(19) United States
(12) Patent Application Publication
(10) Pub. No.: US 2012/0291541 A1
(43) Pub. Date: Nov. 22, 2012

(54) DIGITAL FIELD-INDUCTION WATER-LEVEL INTELLIGENT SENSING SYSTEM AND ITS IMPLEMENTATION METHOD

(76) Inventors: Dafan Liu, Huizhou (CN); Weixin Shi, Huizhou (CN); Zhihui Zhou, Huizhou (CN)

(21) Appl. No.: 13/521,396

(22) PCT Filed: Oct. 15, 2010
(86) PCT No.: PCT/CN2010/077789

§ 371 Date: Jul. 10, 2012

(51) Int. Cl. G01F 23/26

(52) U.S. Cl. 73/304 C

(57) ABSTRACT

A digital field-induction water-level intelligent sensing system is provided. The digitalized intelligent field-induction field technology is utilized in the sensing system, thus the problem of water scale formation on the water-level sensors when applied in the severe environment and the problem of sensing system failure easily happening in the high temperature and high humidity environment are solved. The application of the field-induction technology enables the sensing system to detect the water level without electrical connection or mechanical connection, thus the problems of the sensor failure or inaccurate water-level detection caused by the water scale formation are avoided.

### BACKGROUND OF THE INVENTION

1. Field of Invention

The present invention relates to field of sensor technique, and specifically, to a digital field inductive intelligent water level sensing system and an implementing method for the same, which are applicable to various liquid level measurements, and particularly to a water level measurement for a solar water heater.

2. Description of the Related Art

A water level sensor is an instrument capable of sensing a water level and converting sensed water level into variable electrical signal. In the development history of solar energy and solar water heater, the water level sensor plays an important role. Intelligentization and humanization of the water heater are tied to the water level sensor, and a water level measuring and monitoring instrument is more dependent on the water level sensor, thereby operation stability of the water level sensor ensures intelligent control of the whole water heater.

Prior art water level sensors often need to sense a water level through electrical or mechanical connections, and changes in materials and environments are important factors to measurement accuracy and operation stability of the water level sensor.

Prior art water level sensor operates based on the following principle: the sensor is identified with different water level sections, each of which one conductive copper foil is provided on (some sensors are injection molded with silica silicone rubber package, and thus conductive silicone rubber is used as the conductive copper foil), each copper foil is connected with one resistor (sometimes, several resistors), and these resistors have a common terminal connected together and to the copper foil at a lowest point of the sensor probe; with principle for conductivity of water, when different copper foils identified on the sensor are immersed into water, the immersed copper foil and the copper foil at the lowest point are connected, that is, resistors between the two connected copper foils are shorted, so that resistance is reduced, and thus resistance of the whole sensor is reduced; then, a host can determine the water level by measuring the resistance of the whole sensor.

Prior art water level sensors have the following shortages: since prior art sensors determine the water level through conductivity of water, and conductivities for different water qualities and water tanks of different sizes (which will influence water storage capacity thereof) are different, measurement accuracy of the sensor are thus influenced, resulting in problems of an inaccurate measurements of a water level in the sensors. Further, since prior art sensor will contact with water, a non-conductive incrustation layer is easily formed on the sensor and blocks contact between water and copper foils on the sensor, which results in a disadvantage effect on prior art methods for measuring a water level, causing inaccurate measurements for the water level so that prior art water level sensing solutions can not be applied on a large scale.

### SUMMARY OF INVENTION

An object of the present invention is to overcome above disadvantages in prior art. There is provided a digital field inductive intelligent water level sensing system, which utilizes an intelligent digital field inductive technique to solve the problems of forming of an incrustation layer on a water level sensor in atrocious environments and failure of the sensing system easily occurring in high temperature high humidity environments, to sense a water level without electrical or mechanical connections, thereby avoiding problems of operation invalidation or an inaccurate measurement for a water level of the sensor due to the incrustation layer.

Another object of the present invention is to provide an implementing method for the above digital field inductive intelligent water level sensing system.

The above objects of the present invention are achieved by the following technical solutions:

A digital field inductive intelligent water level sensing system, characterized in that, including a main control module and a water level sensor probe provided with several water level detecting points, the main control module is provided with:

a capacitance voltage collection-conversion simulation module for obtaining capacitance information of the detecting points real time to calculate analog voltage signals of the water level detecting points;

an analog-digital conversion (A/D) module for converting the analog voltage signals transmitted from the capacitance voltage collection-conversion simulation module into digital voltage signals;

a digital filter module for filtering out interfering signals in the digital voltage signals transmitted from the analog-digital conversion (A/D) module real time and then transmitting filtered digital voltage signals to a water level analyzing module;

the water level analyzing module for comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point; and

a water level voltage threshold storing module for storing the water level voltage threshold;

the water level detecting points are connected with the capacitance voltage collection-conversion simulation module, which in turn is connected with the analog-digital (A/D) conversion module, the digital filter module and the water level analyzing module, and the water level voltage threshold storing module is connected with the water level analyzing module.

Preferably, the main control module is further provided with a automatically updating module, which is used to receive the digital voltage signals filter by the digital filter module real time, analyze whether there is a small time period for which digital voltage signals within a set of collected digital voltage signals change significantly at each water level detecting point during a water level analyzing period or not, and if so, calculate a mean value of the digital voltage signals corresponding to the small time period or take arbitrary one of the digital voltage signals within the small time period to replace the water level voltage threshold stored in the water level voltage threshold storing module, and the automatically updating module is located between the water level voltage threshold storing module and the digital filter module.

Preferably, the number of the water level detecting points is 4.

The water level sensor probe may be of a sealed or non-sealed type.

An implementing method for the digital field inductive intelligent water level sensing system according to claim 1, characterized in that, including following steps:

(1) after the system is started, obtaining capacitance information of the detecting points real time by the capacitance voltage collection-conversion simulation module to calculate analog voltage signals of the water level detecting points;

(2) converting the analog voltage signals transmitted from the capacitance voltage collection-conversion simulation module into digital voltage signals by the analog-digital conversion module;

(3) filtering out interfering signals in the digital voltage signals transmitted from the analog-digital conversion module real time and then transmitting filtered digital voltage signals to the water level analyzing module by the digital filter module; and

(4) by means of the water level analyzing module, comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point.

In step (3) of the above method, filtered digital voltage signals are transmitted to an automatically updating module in real time while being transmitted to the water level analyzing module by the digital filter module, wherein the automatically updating module is used to analyze whether there is a small time period for which digital voltage signals within a set of collected digital voltage signals change significantly at each water level detecting point during a water level analyzing period or not, and if so, calculate a mean value of the digital voltage signals corresponding to the small time period or take arbitrary one of the digital voltage signals within the small time period as a new water level voltage threshold to replace the water level voltage threshold stored in the water level voltage threshold storing module.

The following advantages and effects are achieved by the present invention when compared to prior arts.

The sensors of the present invention utilize an intelligent digital field inductive technique to solve the problems of forming of an incrustation layer on a water level sensor in atrocious environments and failure of the sensing system easily occurring in high temperature high humidity environments, and allow the sensing system to sense a water level without electrical or mechanical connections by using field inductive technique, thereby, normal operations and accuracy of the sensors will not be affected even though the incrustation layer is formed on the probe, avoiding problems of operation invalidation or an inaccurate measurement for a water level of the sensor due to the incrustation layer.

### BRIEF DESCRIPTION OF THE DRAWINGS

FIG. 1 is a schematic view showing a configuration of a digital field inductive intelligent water level sensing system of the present invention;

FIG. 2 is a schematic diagram showing one form of electric field in an embodiment;

FIG. 3 is a schematic diagram showing another form of electric field in the embodiment;

FIG. 4 is a schematic diagram showing one further form of electric field in the embodiment; and

FIG. 5 is a view showing a two-dimensional function relationship between dielectric constants and water levels in the embodiment.

### DETAILED DESCRIPTION OF PREFERRED EMBODIMENTS

The present invention will be further described in detail below in connection with embodiments and accompanying drawings, however, embodiments of the present invention are not limited to those.

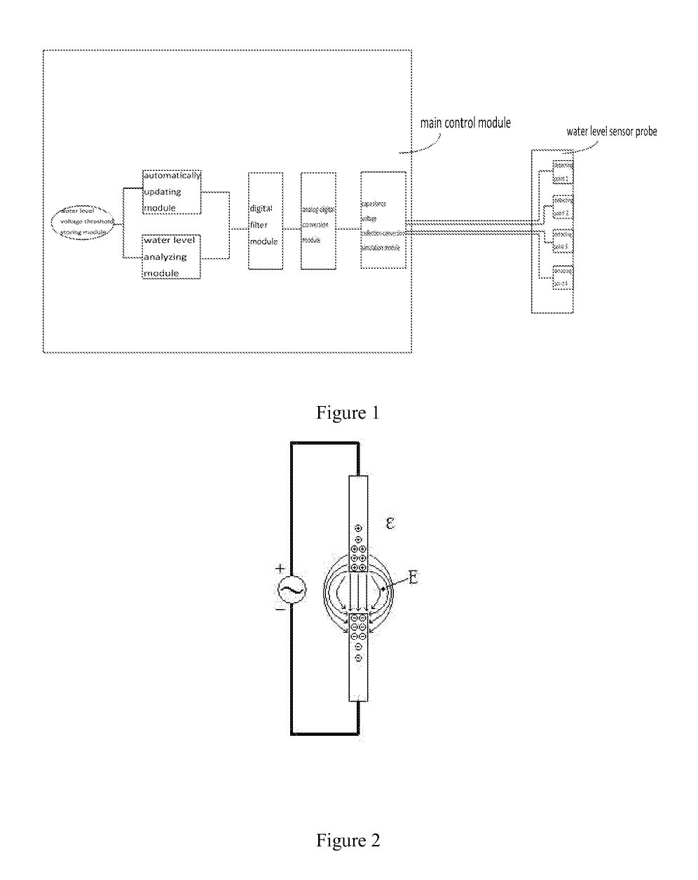

As shown in FIG. 1, a digital field inductive intelligent water level sensing system includes a main control module and a water level sensor probe provided with several water level detecting points (detecting points 1, 2, 3, 4), the main control module is provided with:

a capacitance voltage collection-conversion simulation module for obtaining capacitance information of the detecting points real time to calculate analog voltage signals of the water level detecting points;

an analog-digital conversion (A/D) module for converting the analog voltage signals transmitted from the capacitance voltage collection-conversion simulation module into digital voltage signals;

a digital filter module for filtering out interfering signals in the digital voltage signals transmitted from the analog-digital conversion (A/D) module real time and then transmitting filtered digital voltage signals to a water level analyzing module;

the water level analyzing module for comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point; and

a water level voltage threshold storing module for storing the water level voltage threshold;

the water level detecting points are connected with the capacitance voltage collection-conversion simulation module, which in turn is connected with the analog-digital conversion (A/D) module, the digital filter module and the water level analyzing module, and the water level voltage threshold storing module is connected with the water level analyzing module.

The main control module is further provided with a automatically updating module, which is used to receive the digital voltage signals filter by the digital filter module in real time, analyze whether there is a small time period for which digital voltage signals within a set of collected digital voltage signals change significantly at each water level detecting point during a water level analyzing period or not, and if so, calculate a mean value of the digital voltage signals corresponding to the small time period or take arbitrary one of the digital voltage signals within the small time period to replace the water level voltage threshold stored in the water level voltage threshold storing module, and the automatically updating module is located between the water level voltage threshold storing module and the digital filter module.

An implementing method for the above digital field inductive intelligent water level sensing system includes following steps:

(1) after the system is started, obtaining capacitance information of the detecting points in real time by the capacitance voltage collection-conversion simulation module to calculate analog voltage signals of the water level detecting points;

(2) converting the analog voltage signals transmitted from the capacitance voltage collection-conversion simulation module into digital voltage signals by the analog-digital conversion module (A/D);

(3) filtering out interfering signals in the digital voltage signals transmitted from the analog-digital conversion (A/D) module real time and then transmitting filtered digital voltage signals to the water level analyzing module by the digital filter module and the automatically updating module, and then performing the following steps (4) and (5) at the same time;

(4) by means of the water level analyzing module, comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point;

(5) by means of the automatically updating module, analyzing whether there is a small time period for which digital voltage signals within a set of collected digital voltage signals change significantly at each water level detecting point during a water level analyzing period or not, and if so, calculating a mean value of the digital voltage signals corresponding to the small time period or take arbitrary one of the digital voltage signals within the small time period as a new water level voltage threshold to replace the water level voltage threshold stored in the water level voltage threshold storing module.

The small time period is an experiential value, and is set according to the water level sensor probe and actual conditions of a container for which a water level is to be measured.

Operation principles for the digital field inductive intelligent water level sensing system of the present invention will be further described in detail below, however, the present invention is not limited to these.

Basic Principle:

Considering definition of an electrical field, an electrical potential difference U is applied on two planar conductors (conductive films or sheets), an electrical field is then formed between the two conductors. An electrical field is a vector having a direction directing from the planar conductor accumulating positive charges to the planar conductor accumulating negative charges as shown in FIG. 2, and an electric field intensity between the two planar conductors is E. An electric field intensity within a space is also called as field intensity for short, and the field intensity at a fixing point within the space is associated with parameters such as charge amount Q, a dielectric constant c of a dielectric material, etc.

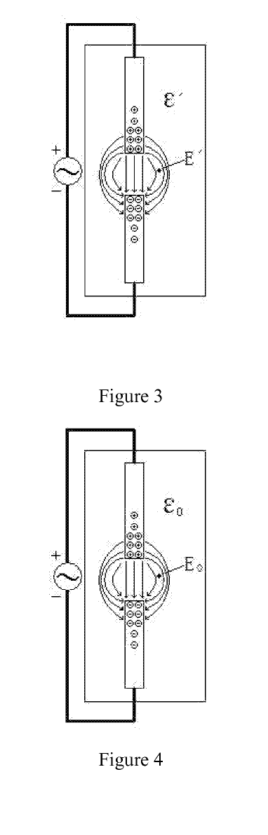

Provided there is no change in environment field intensity at the point is E0 when a dielectric constant of a dielectric material is ∈0, as shown in FIG. 3; the field intensity at the point is E′ when the dielectric constant of the dielectric material is ∈′, as shown in FIG. 4. It can be detected whether there is a conductor between the two planar conductors by detecting changes in the field intensity E.

As such, the case in which presence of water is detected becomes a case in which changes in dielectric constant are detected. For this, changes in charge amount, that is, capacitances, required between the two planar conductors when applied by different electrical potential differences U, are detected. Changes in dielectric constant and field intensity can be detected by measuring changes in capacitance, thereby presence of water can be detected.

Actual Applications:

In actual application of measurement for a water level, detecting presence or absence of water does not represent the water level. Although changes in amount of water will result in changes in capacitance, absolute capacitances obtained from changes in amount of water are minute and such changes will be covered up by parasitic capacitances of the system as noises. In contrast, in the present invention, presence of water at different positions is detected by using different position distribution to determine the water level. The following contents shows one case.

Digitization technique by analog-digital conversion is what converts analog values of field intensity into digital values by circuits, and performs detections and intelligent corrections by software to adapt a sensing system to changes in environment in order to achieve a stable detection.

There are various methods for measuring a capacitance voltage, including a RC charging and discharging circuit, an RC oscillating circuit, a voltage multiplying circuit (all of which can be used as a capacitance voltage collection-conversion simulation module), etc., through which circuits changes in capacitance is converted into changes in voltage. Since a voltage is an analog value, it needs to convert a voltage analog value into a digital value, that is, perform an analog-digital conversion, in order to achieve accurate detections and intelligent corrections. Although detecting changes in capacitance within a relatively short time period can achieve detections of a water level within a short time period, changes in a detection environment occurring over time in a terrible environment, especially changes in dielectric constant due to aging of materials in the sensor system, result in an error detection of the water level.

In the present invention, detected a water level is intelligently corrected by using digital information after analog-digital conversion and through data processing. The specific method is as follows:

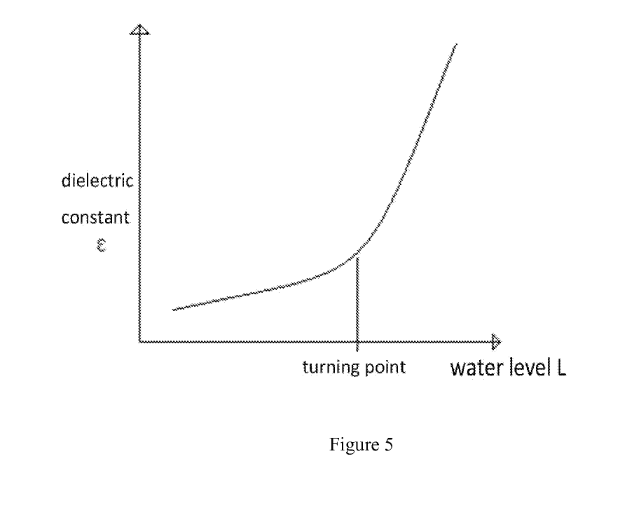

When water level changes, changes of the horizontal plane with respect to respective planar conductors of the sensing system is continuous, rather than being abrupt, in other words, an average dielectric constant in a space changes continuously, and thus changes in capacitance are also continuous. However, there is a turning point in such changes when meeting certain conditions, as shown in FIG. 5. The turning point, that is, detection point at which presence of water, is obtained through data processing. An advantage of detecting the turning point is in that changes in dielectric constant due to changes in environment do not affect detection of presence of the turning point, thus the method can solve problems such as aging of the sensing system or changes in environment.

The following refers to basic derivations for principles of field inductive water level measurement according to the present invention:

1. Based on the electric field intensity theory, an electric field intensity E is a function f₁ of a dielectric constant ∈, wherein E=f₁(∈);

2. Based on definition of the electric field intensity, U=E*d, wherein U is an electrical potential difference, and d is a distance between two conductors;

3. Based on definition of capacitance, C=Q/U, wherein Q is charge amount, and U is the electrical potential difference;

4. C=Q/(E*d) can be derived from above formulas, and in combination with E=f₁(∈), it can be obtained that C=f₂(∈), wherein C is the capacitance, c is the dielectric constant, and f₂ is a function relationship between the capacitance and the dielectric constant;

5. By using a capacitance-voltage conversion circuit such an RC oscillating circuit, it can be obtained that u=f₃(C), wherein u is an analog voltage value after converted, and f₃ is a function relationship between the capacitance and the analog voltage value;

6. By using a analog-digital conversion circuit such an ADC integrated circuit, it can be obtained that Y=f₄(U), wherein Y is a digital voltage value after converted, and f₄ is a function relationship between the analog voltage value and the digital voltage value; and

7. Changes in a water level will result in changes in average dielectric constant within a space, that is, ∈=f₆(L), wherein L is a water level, and f₅ is a function relationship between the water level and the dielectric constant.

According to above aspects 4, 5, 6, and 7, it can be obtained that Y=f₇(L), wherein f₇ is a function relationship between the digital voltage value and water level. In a case where a sensing system has been chosen, f₇ does not change, thereby a one-by-one relationship between the digital voltage value Y and the water level L can be obtained.

The above embodiments are described as preferred embodiments of the present invention, however, the present invention is not limited the above embodiments. Any other changes, modifications, alternatives, simplifications, combinations, etc. without departing from the true spirit and principle of the present invention should be considered as equivalent substitutes and included within scopes of the present invention.

What is claimed is:

1. A digital field inductive intelligent water level sensing system, characterized in that, including a main control module and a water level sensor probe provided with several water level detecting points, the main control module is provided with:
a capacitance voltage collection-conversion simulation module for obtaining capacitance information of the detecting points in real time to calculate analog voltage signals of the water level detecting points;
an analog-digital conversion module for converting the analog voltage signals transmitted from the capacitance voltage collection-conversion simulation module into digital voltage signals;
a digital filter module for filtering out interfering signals in the digital voltage signals transmitted from the analog-digital conversion module in real time and then transmitting filtered digital voltage signals to a water level analyzing module;
the water level analyzing module for comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point; and
a water level voltage threshold storing module for storing the water level voltage threshold;
the water level detecting points are connected with the capacitance voltage collection-conversion simulation module, which in turn is connected with the analog-digital conversion module, the digital filter module and the water level analyzing module, and the water level voltage threshold storing module is connected with the water level analyzing module.

2. The digital field inductive intelligent water level sensing system according to claim 1, characterized in that,
the main control module is further provided with a automatically updating module, which is used to receive the digital voltage signals filter by the digital filter module real time, analyze whether there is a small time period for which digital voltage signals within a set of collected digital voltage signals change significantly at each water level detecting point during a water level analyzing period or not, and if so, calculate a mean value of the digital voltage signals corresponding to the small time period or take arbitrary one of the digital voltage signals within the small time period to replace the water level voltage threshold stored in the water level voltage threshold storing module, and
the automatically updating module is located between the water level voltage threshold storing module and the digital filter module.

3. The digital field inductive intelligent water level sensing system according to claim 1, characterized in that,
the water level sensor probe is of a sealed or non-sealed type.

4. The digital field inductive intelligent water level sensing system according to claim 1, characterized in that,
the number of the water level detecting points is 4.

5. An implementing method for the digital field inductive intelligent water level sensing system according to claim 1, characterized in that, including following steps:
(1) after the system is started, obtaining capacitance information of the detecting points in real time by the capacitance voltage collection-conversion simulation module to calculate analog voltage signals of the water level detecting points;
(2) converting the analog voltage signals transmitted from the capacitance voltage collection-conversion simulation module into digital voltage signals by the analog-digital conversion module;
(3) filtering out interfering signals in the digital voltage signals transmitted from the analog-digital conversion module in real time and then transmitting filtered digital voltage signals to the water level analyzing module by the digital filter module; and
(4) by means of the water level analyzing module, comparing received digital voltage signals with water level voltage threshold stored in the system, determining that no water is present at water level detecting points corresponding to the digital voltage signals when the digital voltage signals are lower than the water level voltage threshold, or else, determining that water is present at water level detecting points corresponding to the digital voltage signals, and taking one of the water level detecting points at which water is present and which is located at the highest position as a water level point.

6. The implementing method for the digital field inductive intelligent water level sensing system according to claim 5, characterized in that,
the small time period is an experiential value, and is set according to the water level sensor probe and actual conditions of a container for which a water level is to be measured.

7. The implementing method for the digital field inductive intelligent water level sensing system according to claim 5, characterized in that,
in step (3), filtered digital voltage signals are transmitted to an automatically updating module in real time while being transmitted to the water level analyzing module by the digital filter module,
wherein the automatically updating module is used to analyze whether there is a small time period for which digital voltage signals within a set of collected digital voltage signals change significantly at each water level detecting point during a water level analyzing period or not, and if so, calculate a mean value of the digital voltage signals corresponding to the small time period or take an arbitrary one of the digital voltage signals within the small time period as a new water level voltage threshold to replace the water level voltage threshold stored in the water level voltage threshold storing module.
